(19) United States
(12) Patent Application Publication
(10) Pub. No.: US 2010/0171308 A1
(43) Pub. Date: Jul. 8, 2010

(54) PLUMBING FITTING WITH O-RING SPACER

(76) Inventors: Brian D. Sanzone, Novi, MI (US); Joseph P. Schutte, Westland, MI (US)

Correspondence Address: Carlson, Gaskey & Olds/Masco Corporation, 400 West Maple Road, Suite 350, Birmingham, MI, 48009, US

(21) Appl. No.: 12/348,496

(22) Filed: Jan. 5, 2009

(51) Int. Cl. F16L 21/02; F16L 35/00

(52) U.S. Cl. 285/379; 285/24

(57) ABSTRACT

A fluid fixture has a body defining an inner peripheral bore to receive a tube. A securement member secures a tube within the body. The securement member is positioned within the inner peripheral bore of said body. A pair of O-rings are spaced along a central axis of the bore. An O-ring spacer is positioned intermediate the O-rings. The O-ring spacer has a nominal outer periphery which is smaller than an inner diameter of the inner peripheral bore. The nominal outer surface includes radially outwardly extending portions which are sized to be larger than the inner diameter of the bore, such that the portions contact the bore, and center the spacer.

### BACKGROUND OF THE INVENTION

This application relates to a quick connect plumbing fitting with an O-ring spacer to be positioned between spaced O-rings.

Plumbing system pipes are utilized to route the flow of water within structures. Traditionally, plumbing pipes were made of rigid material. More recently, flexible tubing has replaced the rigid material.

With the use of the flexible tubing, quick connect couplings have also been adapted to connect the tubing to plumbing fittings.

A reliable seal must be provided at the connection of the tubing to the fitting. Known sealing arrangements may include a plurality of seals. A spacer is sometimes included between the seals. Due to manufacturing tolerances, the spacers have sometimes fallen downwardly such that they can present an obstacle to insertion of the flexible tubing into the fitting for connection.

### SUMMARY OF THE INVENTION

A fluid fixture has a body defining an inner peripheral bore to receive a tube. A securement member secures a tube within the body. The securement member is positioned within the inner peripheral bore of said body. A pair of O-rings are spaced along a central axis of the bore. An O-ring spacer is positioned intermediate the O-rings. The O-ring spacer has a nominal outer periphery which is smaller than an inner diameter of the inner peripheral bore. The nominal outer surface includes radially outwardly extending portions which are sized to be larger than the inner diameter of the bore, such that the portions contact the bore, and center the spacer.

These and other features of the present invention can be best understood from the following specification and drawings, the following of which is a brief description.

### BRIEF DESCRIPTION OF THE DRAWINGS

FIG. 1 shows a plumbing fitting.

FIG. 2 shows a flexible tube inserted into the plumbing fitting.

FIG. 3A shows an O-ring spacer according to this invention.

FIG. 3B shows a detail of a rib on the inventive O-ring spacer.

### DETAILED DESCRIPTION OF THE PREFERRED EMBODIMENT

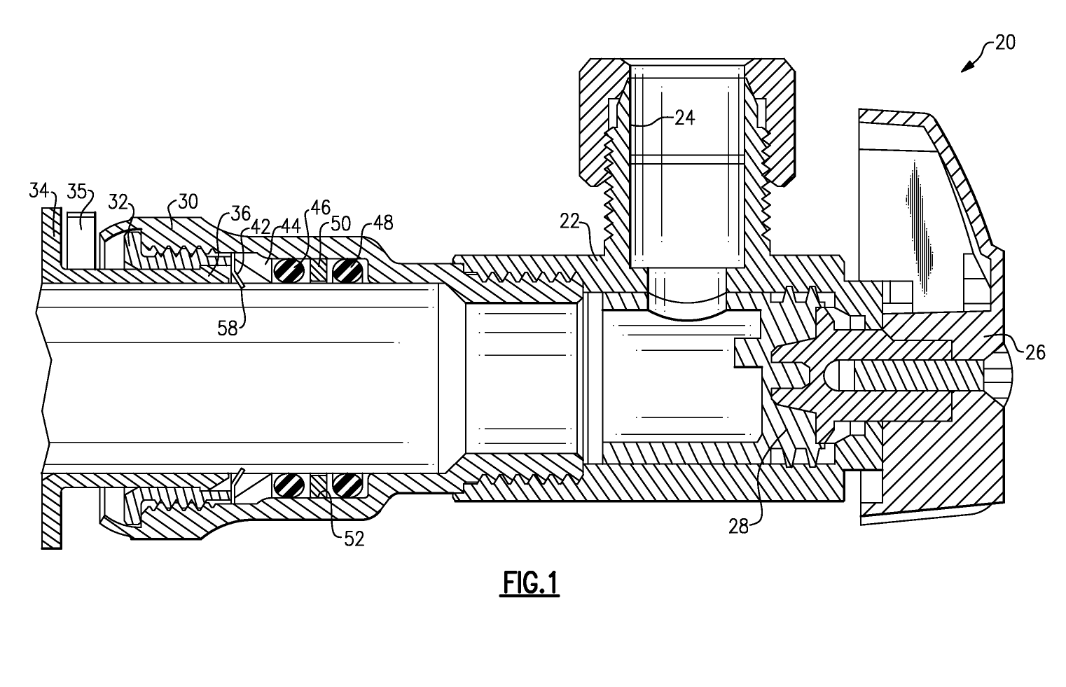

A plumbing assembly 20 is illustrated in FIG. 1 having a valve fitting 22. Valve fitting 22 delivers water to a connection 24 which can lead to a plumbing outlet, such as a faucet or shower. A knob 26 may be rotated to turn a valve 28, and control the flow of water to the outlet 24.

A fitting body 30 receives a closure 32, and a release collet 34. A U-shaped clip 35 holds the release collet 34. An inner end 36 of the collet 34 serves to move a radially inner portion 58 of a spring washer 42, as will be described below.

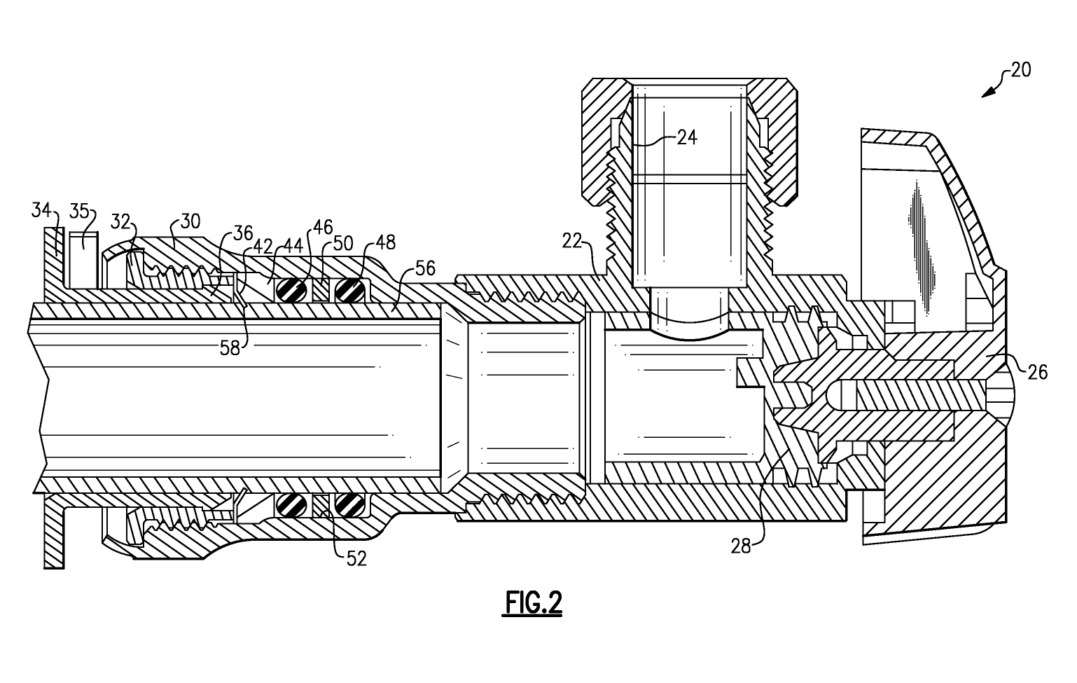

The assembly further includes an element 44, an O-ring 46, and an O-ring 48. A spacer 50 is positioned between the O-rings 46 and 48. As can be seen, the O-rings 46 and 48 are sized such that they are in contact with an inner periphery of a bore in the body 30, and an outer periphery of the tube 56, as shown in FIG. 2.

When a flexible tube 56 is inserted into the fitting body 30, the radial inner portion 58 of the spring washer 42 digs into the outer periphery, thus locking the tube 56 within the fitting.

As can be appreciated from FIG. 2, the collet 34 may be inserted inwardly to release the inner portion 58 from the outer periphery of the tube 56, such that the tube 56 may be removed.

A concern with the spacer 50 has been that due to manufacturing tolerances, etc., it may sometimes be too small to fit properly within the body 30. It can fall and be in the way of the tube's insertion.

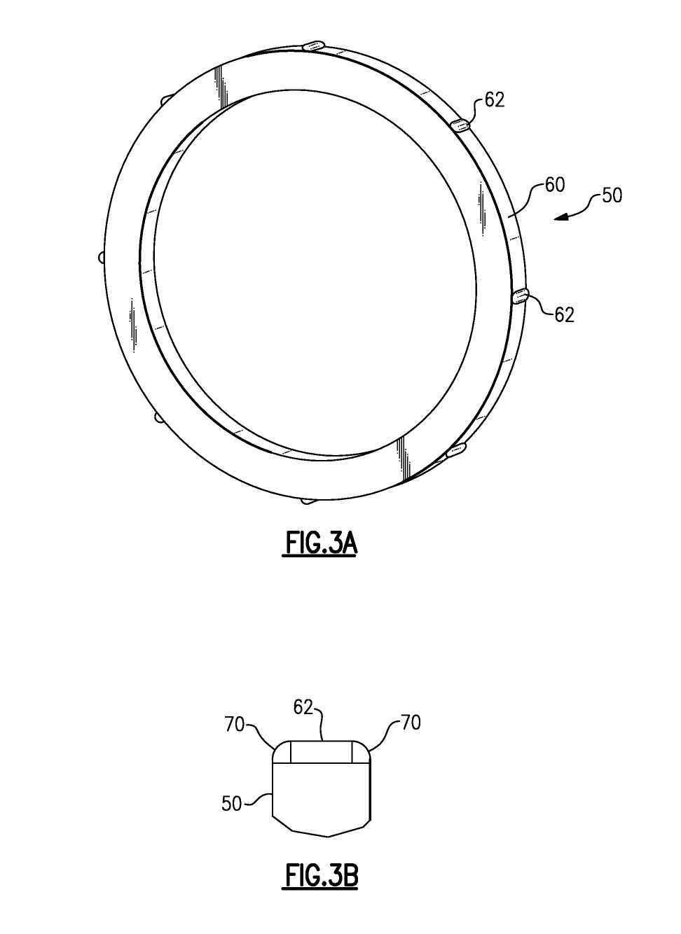

Thus, as shown in FIG. 3, an outer periphery 60 of the spacer 52 is provided with a plurality of ribs 62. These ribs 62 are sized such that they will contact the inner periphery of the body 30, regardless of manufacturing tolerances. The ribs can be crushed, such that the spacer is centered within the body 30, and thus it will not fall, and become an interference with the insertion of the tube 56.

As shown in FIG. 3B, the ribs 62 have rounded radius 70 at each axial end. The rib is selected to be relatively small in height compared to a diameter of the spacer 50. In one example, the diameter to the outer periphery of portion 60 was approximately 0.792″, and the rib extended 0.010″ above that surface. A ratio of the height of the rib to the outer diameter of the spacer may be on the order of 0.025 and 0.006, and more preferably 0.019 and 0.006.

The O-ring 48 may be a nitrile O-ring, while the O-ring 46 may be a viton O-ring. Of course, any other material for any of these components can be utilized. The spacer 50 may be formed of any appropriate resilient material. In one embodiment, acetal M90 is used.

Although an embodiment of this invention has been disclosed, a worker of ordinary skill in this art would recognize that certain modifications would come within the scope of this invention. For that reason, the following claims should be studied to determine the true scope and content of this invention.

1. A fluid fixture comprising:
a body defining an inner peripheral bore to receive a tube;
a securement member for securing said tube within said body, said securement member being positioned within said bore;
a pair of O-rings spaced along a central axis of said bore, said O-rings being sized to contact an inner peripheral surface of said bore; and
an O-ring spacer positioned intermediate said O-rings, said O-ring spacer having a nominal outer periphery which is smaller than an inner diameter of said bore, with said nominal outer periphery of said spacer including radially outwardly extending portions which are sized to be larger than said inner diameter of said bore, such that said portions contact said bore.

2. The fluid fixture as set forth in claim 1, wherein said securement member is a spring washer.

3. The fluid fixture as set forth in claim 1, wherein said pair of O-rings are formed of different material.

4. The fluid fixture as set forth in claim 1, wherein said radially outwardly extending portions are a plurality of ribs formed on said outer periphery, and such that there are over six of said ribs spaced circumferentially about said outer periphery.

5. The fluid fixture as set forth in claim 4, wherein there are eight of said ribs spaced circumferentially about said outer periphery.

6. The fluid fixture as set forth in claim 1, wherein axial ends of said ribs are rounded.

7. The fluid fixture as set forth in claim 4, wherein a ratio of a height of each of said ribs to a diameter of said outer periphery is between 0.025 and 0.006.

8. A fluid fixture comprising:
a body defining an inner peripheral bore to receive a tube;
a spring washer for securing said tube within said body, said spring washer being positioned within said bore;
a pair of O-rings spaced along a central axis of said bore, said O-rings being sized to contact an inner peripheral surface of said bore;
an O-ring spacer positioned intermediate said O-rings, said O-ring spacer having a nominal outer periphery which is smaller than an inner diameter of said bore, with said nominal outer periphery of said spacer including radially outwardly extending portions which are sized to be larger than said inner diameter of said bore, such that said portions contact said inner diameter;
said extending portions are a plurality of ribs formed on said outer periphery, and such that there are over six of said ribs spaced circumferentially about said outer periphery with axial ends of said ribs being rounded; and
a ratio of a height of each of said ribs to a diameter of said outer periphery being between 0.025 and 0.006.
